(19) United States
(12) Patent Application Publication
(10) Pub. No.: US 2025/0284437 A1
(43) Pub. Date: Sep. 11, 2025

(54) METHOD OF RAID IMPLEMENTATION ON FLEXIBLE DATA PLACEMENT DRIVES

(71) Applicant: SanDisk Technologies LLC, Austin, TX (US)

(72) Inventors: SRIDHAR SABESAN, Bangalore (IN); DINESH BABU, Bangalore (IN); PAVAN GURURAJ, Bangalore (IN)

(73) Assignee: SanDisk Technologies LLC, Austin, TX (US)

(21) Appl. No.: 18/599,898

(22) Filed: Mar. 8, 2024

(51) Int. Cl. G06F 3/06

(52) U.S. Cl. CPC G06F 3/0689; G06F 3/0604; G06F 3/0655

(57) ABSTRACT

A storage device may carve out redundant array of independent disks (RAID) and reduce write amplification when writing data to the RAID. The storage device includes multiple flexible data placement drives that are configured to execute RAID techniques. A controller on the storage device may receive data from a host. The controller obtains reclaim unit handles from the data to determine locations where the data is to be stored on the flexible data placement drives. During storage, the controller stripes the data in parallel across reclaim units within different reclaim groups and endurance groups across a single flexible data placement drive or multiple flexible data placement drives. The storage device leverages the write amplification of the flexible data placement drives to reduce a write amplification factor on the RAID.

### BACKGROUND

A storage device may be communicatively coupled to a host and to non-volatile memory including, for example, a NAND flash memory device on which the storage device may store data received from the host. The NAND flash memory may be divided into partitions which may be further divided into blocks, wherein blocks are the smallest units that can be erased from the NAND flash memory. When the host sends a read/write command to the storage device, the host may address the data in the command using logical block addresses. The storage device may store data in blocks on the memory device wherein the logical block addresses sent from the host may be mapped one-to-one to physical addresses on the memory device. The one-to-one logical block address to physical address mappings may be stored in a logical-to-physical (L2P) table.

A controller on the storage device may process background operations, including garbage collection, to manage the resources on the storage device. In managing the resources of the storage device, the controller may move data from one location to another on the memory device to optimize how space on the memory device is used and improve efficiency. In moving data around on the memory device, a write amplification factor (WAF), i.e., a value representing the amount of data the controller writes relative to the amount of data submitted by the host, may increase.

In a redundant array of independent disks (RAID) environment, writes to stripes occur in a sequential manner. The WAF is higher for a storage device used to carve out the RAID. An increased write amplification factor is an undesirable factor which diminishes the overall system performance and increases the media wear on the storage device. As such, the RAID implementation may add overhead and reduce the overall system performance as compared to the storage device performance. To eliminate the reduction of the WAF with overprovisioning, a current flexible data placement protocol provides hints from the host to the storage device about data placement via virtual handles/pointers. The storage device places the data in super blocks based on the hints and advertises the size of the super block. With the flexible data placement, the WAF is almost equal to 1. As writes to stripes in the RAID environment occurs in a sequential manner, storage devices that support flexible data placement may not be implemented in RAID environments.

### SUMMARY

In some implementations, the storage device may carve out redundant array of independent disks (RAID) and reduce write amplification when writing data to the RAID. The storage device includes multiple flexible data placement drives that are configured to execute RAID techniques. A controller on the storage device may receive data from a host. The controller obtains reclaim unit handles from the data to determine locations where the data is to be stored on the flexible data placement drives. During storage, the controller stripes the data in parallel across reclaim units within different reclaim groups on the flexible data placement drives. The storage device leverages the write amplification of the flexible data placement drives to reduce a write amplification factor on the RAID.

In some implementations, a method is provided for reducing write amplification when writing data to redundant array of independent disks (RAID) on a storage device. The method includes receiving data from a host. The method also includes obtaining reclaim unit handles from the data to determine locations where the data is to be stored on flexible data placement drives used to carve out the RAID. The method further includes striping the data in parallel across reclaim units within different reclaim groups on the flexible data placement drives, wherein write amplification of the flexible data placement drives reduces a write amplification factor on the RAID.

In some implementations, storage device may carve out redundant array of independent disks (RAID) and reduce write amplification when writing data to the RAID. The storage device includes a flexible data placement drive that is configured to execute RAID techniques. The flexible data placement drive includes multiple reclaim groups and multiple reclaim unit handles that reference reclaim units in a reclaim group. The storage device also includes a controller to receive data from a host. The controller obtains reclaim unit handles from the data to determine locations where the data is to be stored on the flexible data placement drive. The controller stripes the data in parallel across reclaim units within different reclaim groups on the flexible data placement drive, wherein the storage device leverages the write amplification of the flexible data placement drive to reduce a write amplification factor on the RAID.

### BRIEF DESCRIPTION OF THE SEVERAL VIEWS OF THE DRAWINGS

FIG. 1 is a schematic block diagram of an example system in accordance with some implementations.

FIG. 2 is a block diagram of exemplary RAID 5 implementation wherein data is striped across the Reclaim Units (RU) within different Reclaim Groups (RG) and Endurance Groups (EG) across multiple drives in accordance with some implementations.

FIG. 3 is a block diagram of an exemplary memory device configured to execute RAID techniques by stripping across the reclaim units within different reclaim groups within a single drive in accordance with some implementations.

FIG. 4 is a block diagram of exemplary RAID 5 striping representation on the flexible data placement drive of FIG. 3 in accordance with some implementations.

FIG. 5 is an exemplary matrix of the RAID representation in FIG. 4 wherein data is striped across the reclaim units within different reclaim groups within a single drive in accordance with some implementations.

FIG. 6 is a block diagram of exemplary RAID 5 striping directions on the flexible data placement drive of FIGS. 1 and/or 3 in accordance with some implementations.

FIG. 7 is an example of a flow diagram for performing RAID stripping across flexible placement drives in accordance with some implementations.

FIG. 8 is a diagram of an example environment in which systems and/or methods described herein are implemented.

FIG. 9 is a diagram of example components of one or more devices of FIG. 1.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of implementations of the present disclosure.

The apparatus and method components have been represented where appropriate by conventional symbols in the drawings, showing those specific details that are pertinent to understanding the implementations of the present disclosure so as not to obscure the disclosure with details that will be readily apparent to those of ordinary skill in the art.

### DETAILED DESCRIPTION OF THE INVENTION

The following detailed description of example implementations refers to the accompanying drawings. The same reference numbers in different drawings may identify the same or similar elements.

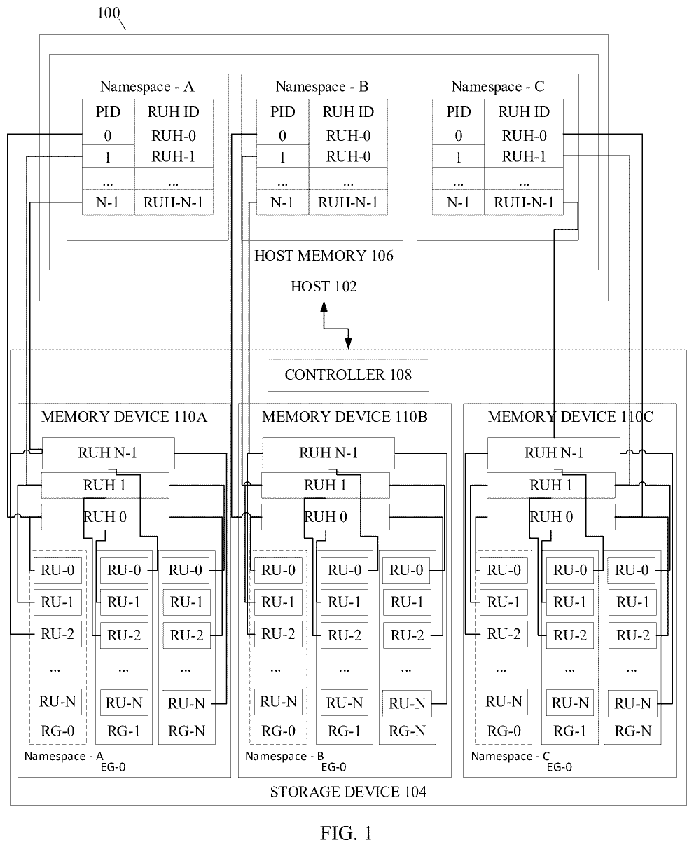

FIG. 1 is a schematic block diagram of an example system in accordance with some implementations. System 100 includes a host 102 and a storage device 104. Host 102 may transmit commands to read data or write data to storage device 104. Host 102 may include a host memory 106 that may store a placement handle list. The placement handle list may store a mapping of placement identifiers (PIDs) with pointers/handle identifiers. When hosts 102 sends data to storage device 104, the data may include a handle identifier for directing storage device 104 to a location where the data associated with a placement identifier is to be stored. Host 102 and storage device 104 may be in the same physical location as components on a single computing device or on different computing devices that are communicatively coupled. Storage device 104, in various implementations, may be disposed in one or more different locations relative to the host 102. Host 102 may include additional components (not shown in this figure for the sake of simplicity).

Storage device 104 may include a controller 108, and one or more non-volatile memory devices 110a-110c (referred to herein as the memory device(s) 110). Storage device 104 may be, for example, a solid-state drive (SSD), and the like. Controller 108 may interface with host 102 and process foreground operations including instructions transmitted from host 102. For example, controller 108 may read data from and/or write to memory device 110 based on instructions received from host 102. Controller 108 may further execute background operations to manage resources on memory device 110. For example, controller 108 may monitor memory device 110 and may execute garbage collection and other relocation functions per internal relocation algorithms to refresh and/or relocate the data on memory device 110.

Memory device 110 may be flash based. For example, memory device 110 may be a NAND flash memory that may be used for storing host and control data over the operational life of memory device 110. Memory device 110 may be included in storage device 104 or may be otherwise communicatively coupled to storage device 104. In an implementation, memory device 110a-110c may be Flexible Data Placement (FDP) supported drives, each of which may include multiple reclaim unit handles (RUH 0-RUH N−1), i.e., a controller resource that references a reclaim unit in a reclaim group. Each of drives 110a-110c may also include multiple reclaim groups (RG-0-RG-N). Each reclaim group may also include multiple reclaim units (RU-0-RU-N), wherein each reclaim unit is a logical representation of non-volatile storage within a reclaim group that is able to be physically erased by controller 108 without disturbing other reclaim units. Each drive 110a-110c may include multiple endurance groups, although only one endurance group, EG-0, is shown for simplicity.

Each of drives 110a-110c may be configured to execute RAID techniques by striping across reclaim units (RU-0-RU-N) within different reclaim groups (RG-0-RG-N) and/or endurance groups across drives 110a-110c in parallel. In each of drives 110a-110c, a namespace (for example, Namespace-A, Namespace-B, and Namespace-C) may be carved out for RG-0, as an example, wherein RAID volumes may be carved out of RG-0. In an exemplary RAID 5 implementation, using the placement handle list in host memory 106, host 102 may direct the placement of data A1, data A2, and parity (Ap) for A1 and A2 using placement identifiers (PIDs) which are mapped to reclaim unit handle identifiers (RUH IDs). The RUH IDs may point to empty or unused RUs on drives 110a-110c. When host 102 sends the data to storage device 104, controller 108 may obtain the RUH IDs from the data and determine locations on drives 110a-110c where the data is to be stored. Controller 108 may implement the first striping and parity wherein data A1 may be written in drive 110a, EG-0, RG-0, RU-0, data A2 may be written in drive 110b, EG-0, RG-0, RU-0, and Ap may be written in drive 110c, EG-0, RG-0, RU-0. As noted, A1, A2, and Ap may be written in parallel, thereby enhancing write performance and leveraging the write amplification factor of almost equal to 1 on the FDP drive.

Consider an example where W, X, and Y are RUH IDs for each drive, wherein D1 may represent drive 110a, D2 may represent drive 110b, and D3 may represent drive 110c, respectively. The data (D) and parity information (P1) sent by host 102 to be stripped in a RAID 5 implementation may be represented in a two-dimensional format with parallelism as:

$$[ \begin{matrix}{WD 1}^{D} & {XD 2}^{\underline{D}} & {YD 3}^{P 1} \\ {W \underline{D 1}}^{D} & {X \underline{D 2}}^{P 1} & {Y \underline{D 3}}^{D} \\ {W \underline{\underline{D 1}}}^{P 1} & {X \underline{\underline{D 2}}}^{D} & {Y \underline{\underline{D 3}}}^{\underline{D}}\end{matrix} ]$$

i.e., [[WD1, XD2, YD3], [WD1, XD2, YD3], [WD1, XD2, YD3]], wherein WD1, XD2, YD3 may represent parallel striping and parity to the first row of the reclaim groups, WD1, XD2, YD3 may represent parallel striping and parity to the second row of the reclaim groups, and WD1, XD2, YD3 may represent parallel striping and parity to the third row of the reclaim groups.

When a RU is to be overwritten, a RUH ID associated with new data that is to be used to overwrite existing data may point to the RU and the RU may be reset or erased during a rewrite. During block update, controller 108 may copy the entire RU data to host 102. Host 102 may update the data and direct storage device 104 to overwrite the RU, using the RUH ID. When controller 108 receives the data with the RUH ID, controller may overwrite the current data in the RU with the updated data from host 102.

Storage device 104 may perform these processes based on a processor, for example, controller 108 executing software instructions stored by a non-transitory computer-readable medium, such as storage component 110. As used herein, the term “computer-readable medium” refers to a non-transitory memory device. Software instructions may be read into storage component 110 from another computer-readable medium or from another device. When executed, software instructions stored in storage component 110 may cause controller 108 to perform one or more processes described herein. Additionally, or alternatively, hardware circuitry may be used in place of or in combination with software instructions to perform one or more processes described herein. Thus, implementations described herein are not limited to any specific combination of hardware circuitry and software. System 100 may include additional components (not shown in this figure for the sake of simplicity). FIG. 1 is provided as an example. Other examples may differ from what is described in FIG. 1.

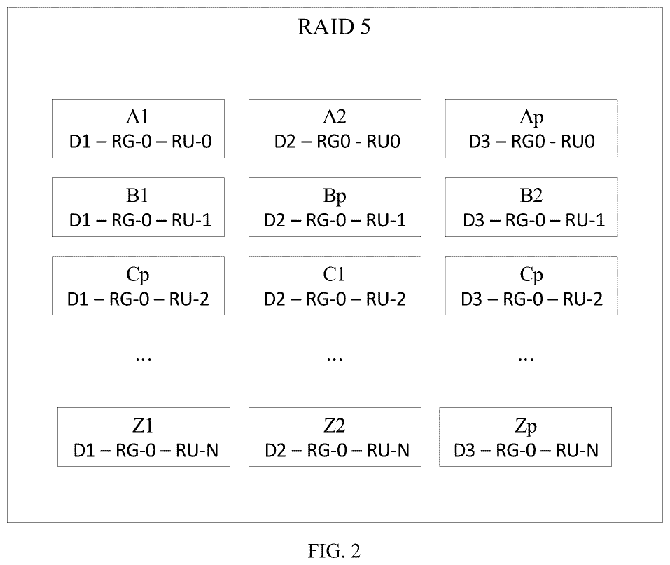

FIG. 2 is a block diagram of exemplary RAID 5 implementation wherein data is striped across the Reclaim Units (RU) within different Reclaim Groups (RG) and Endurance Groups (EG) across multiple drives in accordance with some implementations. FIG. 2 shows an example where host 102 may send data A1, A2, B1, B2, C1, C2 up to Z1 and Z2, and parity (Ap) for A1 and A2, parity (Bp) for B1 and B2, parity (Cp) for C1 and C2, up to parity (Zp) for Z1 and Z2 to storage device 104 with handle identifiers. Controller 108 may implement a first striping and parity wherein data A1 may be written in drive 1 (D1), EG-0, RG-0, RU-0, data A2 may be written in drive 2 (D2), EG-0, RG-0, RU-0, and parity Ap may be written in drive 3 (D3), EG-0, RG-0, RU-0. Controller 108 may implement the next striping and parity wherein data B1 may be written in D1, EG-0, RG-0, RU-1, parity Bp may be written in D2, EG-0, RG-0, RU-1, and data B2 may be written in D3. EG-0, RG-0, RU-1. The next striping and parity may be implemented wherein parity Cp may be written in D1, EG-0, RG-0, RU-2, data C1 may be written in D2, EG-0, RG-0, RU-2, and data C2 may be written in D3, EG-0, RG-0, RU-2, and so on. As noted in FIG. 1, reclaim units from multiple endurance groups and multiple reclaim groups may be used for the RAID 5 creation. As indicated above FIG. 2 is provided as an example. Other examples may differ from what is described in FIG. 2.

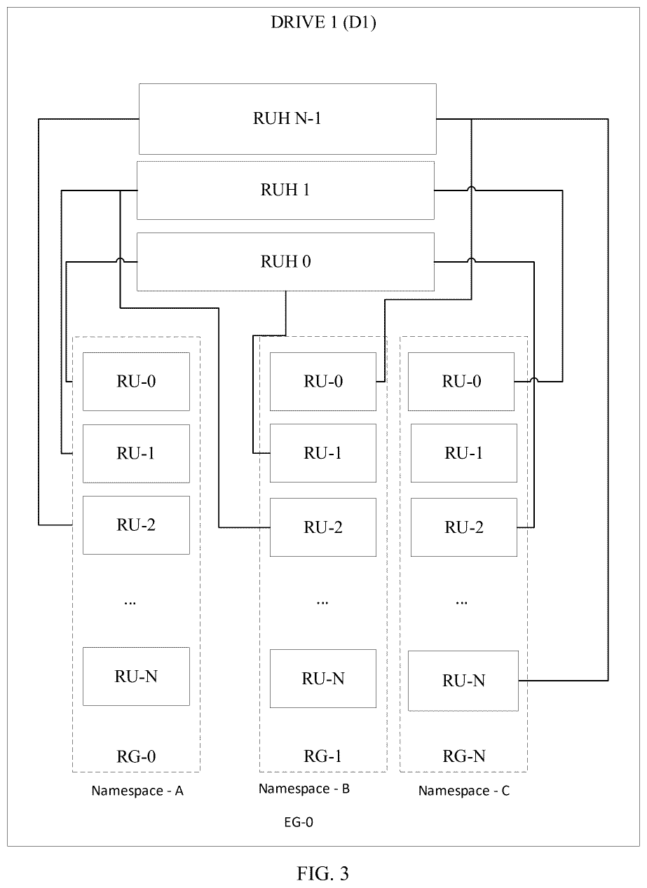

FIG. 3 is a block diagram of an exemplary memory device configured to execute RAID techniques by striping across the reclaim units within different reclaim groups within a single drive in accordance with some implementations. Memory device 110 may be a single FDP supported drive with multiple RUHs (RUH 0-RUH N−1), multiple endurance groups (although only EG 0 is shown for simplicity), and multiple reclaim groups (RG-0-RG-N), each with multiple reclaim units (RU-0-RU-N). Namespace-A, Namespace-B and Namespace-C may be carved out from the single drive (D1), as an example, and RAID volumes may be carved out of the namespaces.

In an exemplary RAID 5 implementation, host 102 may direct the placement of data A1, data A2, and parity (Ap) for A1 and A2 using placement identifiers (PIDs) which are mapped to reclaim unit handle identifiers (RUH IDs). The RUH IDs may point to empty or unused RUs on D1. When host 102 sends the data to storage device 104, controller 108 may obtain the RUH IDs from the data and determine locations on D1 where the data is to be stored. Controller 108 may implement the first striping and parity wherein data A1 may be written in D1, EG-0, RG-0, RU-0, data A2 may be written in D1, EG-0, RG-1, RU-0, and parity Ap for A1 and A2 may be written in D1, EG-0, RG-2, RU-0. A1, A2, and Ap may be written in parallel, thereby enhancing write performance and leveraging the write amplification factor that is almost equal to 1 on the FDP drive. As indicated above FIG. 3 is provided as an example. Other examples may differ from what is described in FIG. 3.

FIG. 4 is a block diagram of exemplary RAID 5 striping representation on the flexible data placement drive of FIG. 3 in accordance with some implementations. FIG. 4 also shows an example where host 102 may send data A1, A2, B1, B2, C1, C2 up to Z1 and Z2, and parity (Ap) for A1 and A2, parity (Bp) for B1 and B2, parity (Cp) for C1 and C2, up to parity (Zp) for Z1 and Z2 to storage device 104 with handle identifiers. Controller 108 may implement the first striping and parity wherein data A1 may be written in drive 1, RG-0, RU-0, data A2 may be written in drive 1, RG-1, RU-0, and Ap may be written in drive 1, RG-2, RU-0. The next striping and parity may be implemented wherein data B1 may be written on drive 1, RG-0, RU-1, Bp may be written in drive 1, RG-1, RU-1, and data B2 may be written in drive 1, RG-2, RU-1. The next striping and parity may be implemented wherein Cp may be written in drive 1, RG-0, RU-2, data C1 may be written in drive 1, RG-1, RU-2, and data C2 may be written in drive 1, RG-2, RU-2, and so on. As indicated above FIG. 4 is provided as an example. Other examples may differ from what is described in FIG. 4.

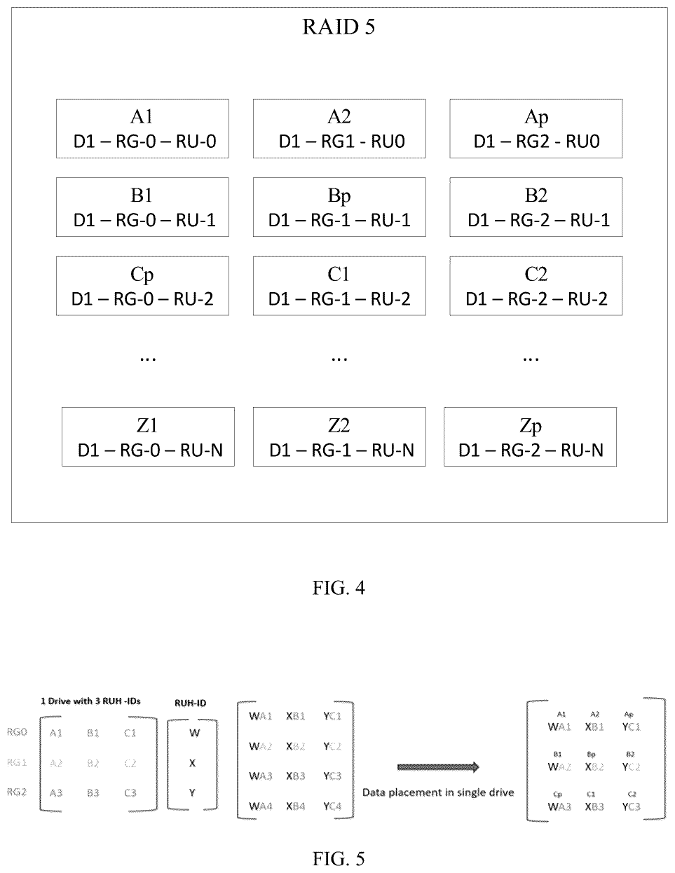

FIG. 5 is an exemplary matrix of the RAID representation in FIG. 4 as provided by the host to the controller in accordance with some implementation. In this example, a single drive includes three RUHs, with RUH ID-W, X, and Y. If the drive has multiple RGs (for example, RG 0, RG 1, and RG 2) and A1-A3, B1-B3, and C1-C3 represent the data to be stored on the RUs, the data may be represented in the two-dimensional format of FIG. 5. As indicated above FIG. 5 is provided as an example. Other examples may differ from what is described in FIG. 5.

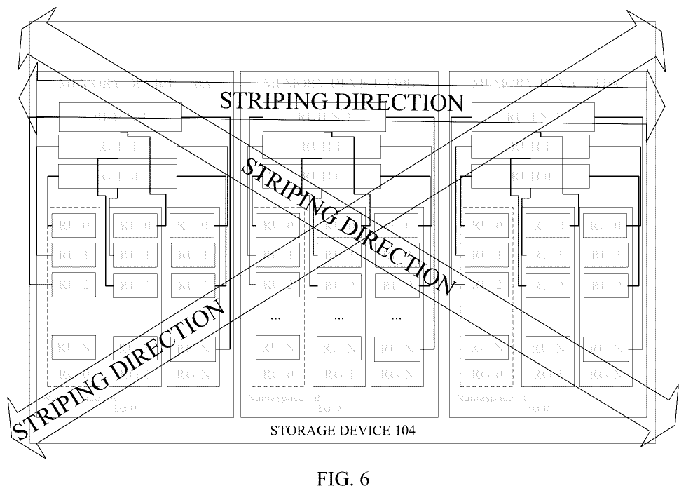

FIG. 6 is a block diagram of exemplary RAID 5 striping directions on the flexible data placement drive of FIGS. 1 and/or 3 in accordance with some implementations. The striping or parity may be done in any direction. As such, the RAID creation can be in any multi-dimensional matrix forming “N” number of combinations. This may further help when there is tiering within the carving of the FDP volume and more so in a heterogenous environment. Additionally, the multi-dimensional matrix may help in write parallelism across RUs in any direction. The configuration of memory device 110 may be used in various RAID implementations including, for example, RAID 0, RAID 1, RAID 6, RAID 10, RAID 50, RAID 60, etc. As indicated above FIG. 6 is provided as an example. Other examples may differ from what is described in FIG. 6.

The memory devices of FIGS. 1 and 3 may also be configured to execute RAID techniques to write data in parallel in any multi-dimensional format, thereby enhancing the write performance on RAID volumes. Read operations and the prefetch of data may also be executed faster. The WAF may be reduced to be almost equal to 1 for the RAID volumes. Depending upon the RAID levels, list structure may be pre-defined by the RAID controller. This structuring may be done during the initialization part of the RAID level. The RAID implementations shown in FIGS. 1 and 3 may avoid creating a RAID pool and provide parallel writing to each RU. The RAID implementations shown in FIGS. 1 and 3 may also improve latency and controller 108 may perform parity calculations at the RU level. Predefined data striping may be leveraged for artificial intelligence and machine learning workloads.

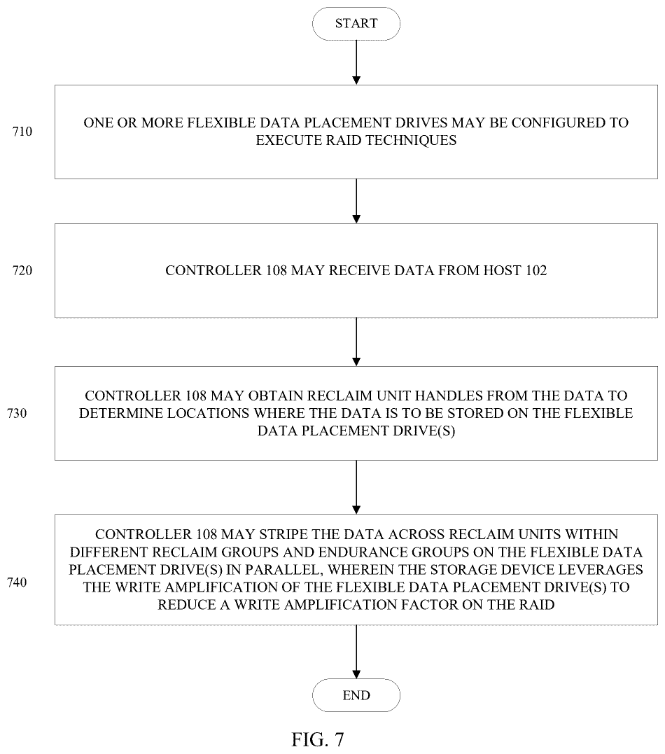

FIG. 7 is an example of a flow diagram for performing RAID striping across flexible placement drives in accordance with some implementations. At 710, one or more flexible data placement drives may be configured to execute RAID techniques. At 720, controller 108 may receive data from host 102. At 730, controller 108 may obtain reclaim unit handles from the data to determine locations where the data is to be stored on the flexible data placement drive(s). At 740, controller 108 may stripe the data across reclaim units within different reclaim groups on the flexible data placement drive(s) in parallel, wherein the storage device leverages the write amplification of the flexible data placement drive(s) to reduce a write amplification factor on the RAID. As indicated above FIG. 7 is provided as an example. Other examples may differ from what is described in FIG. 7.

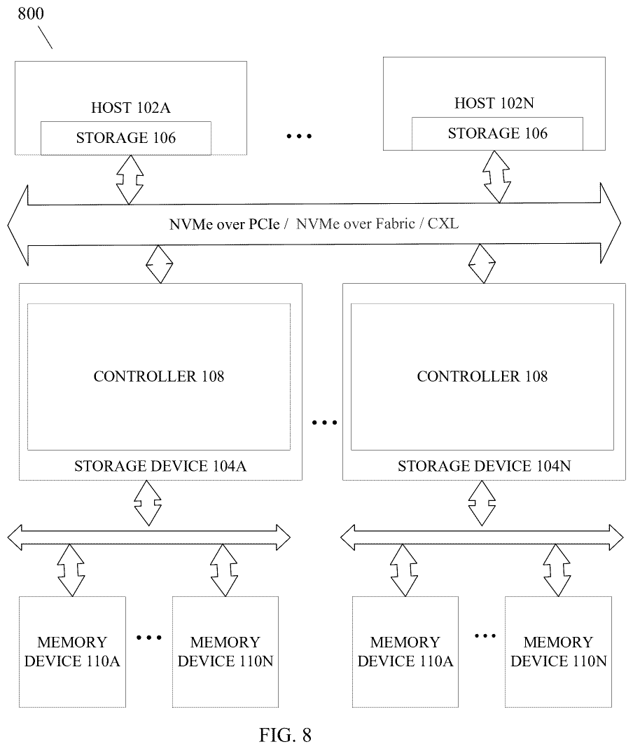

FIG. 8 is a diagram of an example environment in which systems and/or methods described herein are implemented. As shown in FIG. 8, Environment 800 may include hosts 102-102n (referred to herein as host(s) 102), and storage devices 104a-104n (referred to herein as storage device(s) 104). Storage device 104 may include a controller 108 to receive reclaim unit handles from host and to use the reclaim unit handles in determining locations where the data is to be striped on flexible data placement drives in parallel. Hosts 102 and storage devices 104 may communicate via Non-Volatile Memory Express (NVMe) over peripheral component interconnect express (PCI Express or PCIe)/NVMe over Fabric/Computer Express Link (CXL) or the like, or the like.

Devices of Environment 800 may interconnect via wired connections, wireless connections, or a combination of wired and wireless connections. For example, the network in FIG. 8 may include NVMe over Fabric (NVMe-oF) Internet Small Computer Systems Interface (iSCSI), Fibre Channel (FC), Fibre Channel Over Ethernet (FCoE) connectivity and any another type of next-generation network and storage protocols, a local area network (LAN), a wide area network (WAN), a metropolitan area network (MAN), a private network, an ad hoc network, an intranet, the Internet, a fiber optic-based network, a cloud computing network, or the like, and/or a combination of these or other types of networks.

The number and arrangement of devices and networks shown in FIG. 8 are provided as an example. In practice, there may be additional devices and/or networks, fewer devices and/or networks, different devices and/or networks, or differently arranged devices and/or networks than those shown in FIG. 8. Furthermore, two or more devices shown in FIG. 8 may be implemented within a single device, or a single device shown in FIG. 8 may be implemented as multiple, distributed devices. Additionally, or alternatively, a set of devices (e.g., one or more devices) of Environment 800 may perform one or more functions described as being performed by another set of devices of Environment 800.

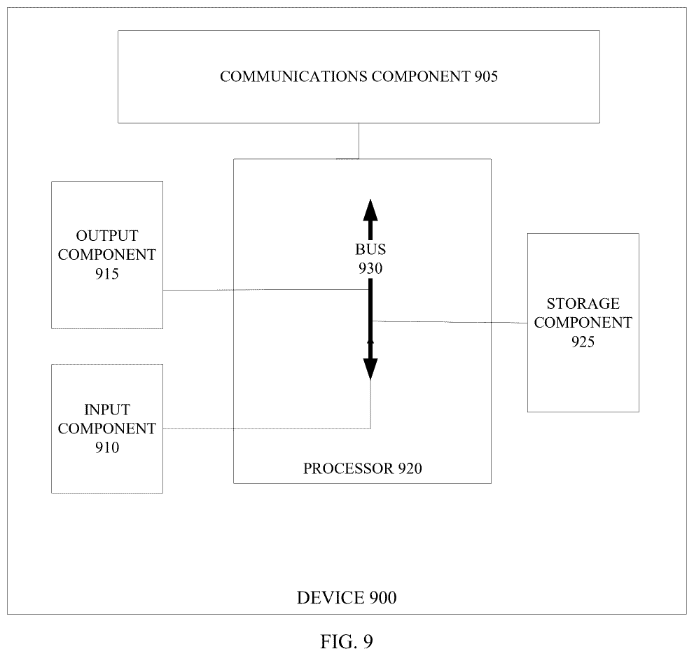

FIG. 9 is a diagram of example components of one or more devices of FIG. 1. In some implementations, host 102 may include one or more devices 900 and/or one or more components of device 900. Device 900 may include, for example, a communications component 905, an input component 910, an output component 915, a processor 920, a storage component 925, and a bus 930. Bus 930 may include components that enable communication among multiple components of device 900, wherein components of device 900 may be coupled to be in communication with other components of device 900 via bus 930.

Input component 910 may include components that permit device 900 to receive information via user input (e.g., keypad, a keyboard, a mouse, a pointing device, and a network/data connection port, or the like), and/or components that permit device 900 to determine the location or other sensor information (e.g., an accelerometer, a gyroscope, an actuator, another type of positional or environmental sensor). Output component 915 may include components that provide output information from device 900 (e.g., a speaker, display screen, and network/data connection port, or the like). Input component 910 and output component 915 may also be coupled to be in communication with processor 920.

Processor 920 may be a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some implementations, processor 920 may include one or more processors capable of being programmed to perform a function. Processor 920 may be implemented in hardware, firmware, and/or a combination of hardware and software.

Storage component 925 may include one or more memory devices, such as random-access memory (RAM) 114, read-only memory (ROM), and/or another type of dynamic or static storage device (e.g., a flash memory, a magnetic memory, and/or optical memory) that stores information and/or instructions for use by processor 920. A memory device may include memory space within a single physical storage device or memory space spread across multiple physical storage devices. Storage component 925 may also store information and/or software related to the operation and use of device 900. For example, storage component 925 may include a hard disk (e.g., a magnetic disk, an optical disk, and/or a magneto-optic disk), a solid-state drive (SSD), a compact disc (CD), a digital versatile disc (DVD), a floppy disk, a cartridge, a magnetic tape, CXL device and/or another type of non-transitory computer-readable medium, along with a corresponding drive.

Communications component 905 may include a transceiver-like component that enables device 900 to communicate with other devices, such as via a wired connection, a wireless connection, or a combination of wired and wireless connections. The communications component 905 may permit device 900 to receive information from another device and/or provide information to another device. For example, communications component 905 may include an Ethernet interface, an optical interface, a coaxial interface, an infrared interface, a radio frequency (RF) interface, a universal serial bus (USB) interface, a Wi-Fi interface, and/or a cellular network interface that may be configurable to communicate with network components, and other user equipment within its communication range. Communications component 905 may also include one or more broadband and/or narrowband transceivers and/or other similar types of wireless transceiver configurable to communicate via a wireless network for infrastructure communications. Communications component 905 may also include one or more local area network or personal area network transceivers, such as a Wi-Fi transceiver or a Bluetooth transceiver.

Device 900 may perform one or more processes described herein. For example, device 900 may perform these processes based on processor 920 executing software instructions stored by a non-transitory computer-readable medium, such as storage component 925. As used herein, the term “computer-readable medium” refers to a non-transitory memory device. Software instructions may be read into storage component 925 from another computer-readable medium or from another device via communications component 905. When executed, software instructions stored in storage component 925 may cause processor 920 to perform one or more processes described herein. Additionally, or alternatively, hardware circuitry may be used in place of or in combination with software instructions to perform one or more processes described herein. Thus, implementations described herein are not limited to any specific combination of hardware circuitry and software.

The number and arrangement of components shown in FIG. 9 are provided as an example. In practice, device 900 may include additional components, fewer components, different components, or differently arranged components than those shown in FIG. 9. Additionally, or alternatively, a set of components (e.g., one or more components) of device 900 may perform one or more functions described as being performed by another set of components of device 900.

The foregoing disclosure provides illustrative and descriptive implementations but is not intended to be exhaustive or to limit the implementations to the precise form disclosed herein. One of ordinary skill in the art will appreciate that various modifications and changes can be made without departing from the scope of the present disclosure as set forth in the claims below. Accordingly, the specification and figures are to be regarded in an illustrative rather than a restrictive sense, and all such modifications are intended to be included within the scope of present teachings.

As used herein, the term “component” is intended to be broadly construed as hardware, firmware, and/or a combination of hardware and software, It will be apparent that systems and/or methods described herein may be implemented in different forms of hardware, firmware, and/or a combination of hardware and software.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set.

No element, act, or instruction used herein should be construed as critical or essential unless explicitly described as such. Also, as used herein, the articles “a” and “an” are intended to include one or more items and may be used interchangeably with “one or more.” Furthermore, as used herein, the term “set” is intended to include one or more items (e.g., related items, unrelated items, a combination of related items, unrelated items, and/or the like), and may be used interchangeably with “one or more.” The term “only one” or similar language is used where only one item is intended. Further, the phrase “based on” is intended to mean “based, at least in part, on” unless explicitly stated otherwise.

Moreover, in this document, relational terms such as first and second, top and bottom, and the like, may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, or “contains . . . a” does not, without more constraints, preclude the existence of additional identical elements in the process, method, article, or apparatus that comprises, has, includes, contains the element. The terms “substantially”, “essentially”, “approximately”, “about” or any other version thereof, are defined as being close to as understood by one of ordinary skill in the art, and in one non-limiting implementation, the term is defined to be within 10%, in another implementation within 5%, in another implementation within 1% and in another implementation within 0.5%. The term “coupled” as used herein is defined as connected, although not necessarily directly and not necessarily mechanically. A device or structure that is “configured” in a certain way is configured in at least that way but may also be configured in ways that are not listed.

We claim:

1. A storage device to carve out redundant array of independent disks (RAID) and reduce write amplification when writing data to the RAID, the storage device comprises:
multiple flexible data placement drives that are configured to execute RAID techniques; and
a controller to receive data from a host, obtain reclaim unit handles from the data to determine locations where the data is to be stored on flexible data placement drives, and stripe the data across reclaim units within different reclaim groups on the flexible data placement drives in parallel, wherein the storage device leverages the write amplification of the flexible data placement drives to reduce a write amplification factor on the RAID.

2. The storage device of claim 1, wherein a flexible placement drive includes different reclaim groups in at least one endurance group and a reclaim group includes multiple reclaim units.

3. The storage device of claim 1, wherein a namespace is carved out of a flexible placement drive for a reclaim group, wherein RAID volumes are carved out of the reclaim groups.

4. The storage device of claim 1, wherein a reclaim unit handle points to one of an empty and unused reclaim unit.

5. The storage device of claim 1, wherein a reclaim unit is one of reset and erased during a rewrite.

6. The storage device of claim 1, wherein during a block update, the controller copies an entire data from a reclaim unit to the host, wherein when the host updates the data and sends updated data with a reclaim unit handle to the storage device, the controller uses the reclaim unit handle to locate an associated reclaim unit and writes the updated data to the reclaim unit.

7. The storage device of claim 1, wherein the controller performs striping and parity in any direction on the flexible data placement drives.

8. The storage device of claim 1, wherein the controller receives a multi-dimensional matrix forming any number of combinations with parallelism for striping data and parity on the flexible data placement drives.

9. The storage device of claim 1, wherein the controller performs parity calculations at a reclaim unit level.

10. A method for reducing write amplification when writing data to redundant array of independent disks (RAID) on a storage device, the storage device comprises a controller to execute the method comprising:
receiving data from a host;
obtaining reclaim unit handles from the data to determine locations where the data is to be stored on flexible data placement drives use to carve out the RAID; and
striping the data across reclaim units within different reclaim groups on the flexible data placement drives in parallel, wherein write amplification of the flexible data placement drives reduces a write amplification factor on the RAID.

11. The method of claim 10, further comprising carving out a namespace of a flexible placement drive for a reclaim group and carving out RAID volumes from the reclaim groups, wherein the flexible placement drive includes different reclaim groups in at least one endurance group.

12. The method of claim 10, wherein during a block update, the method further comprises copying an entire data for a reclaim unit to the host, wherein when the host updates the data and sends updated data with a reclaim unit handle to the storage device, the method comprises using the reclaim unit handle to locate an associated reclaim unit, and writing the updated data to the reclaim unit.

13. The method of claim 10, further comprising performing striping and parity in any direction on the flexible data placement drives.

14. The method of claim 10, further comprising receiving a multi-dimensional matrix forming any number of combinations with parallelism for striping data and parity on the flexible data placement drives.

15. The method of claim 10, further comprising performing parity calculations at a reclaim unit level.

16. A storage device to carve out redundant array of independent disks (RAID) and reduce write amplification when writing data to the RAID, the storage device comprises:
a flexible data placement drive that is configured to execute RAID techniques, the flexible data placement drive includes multiple reclaim groups and multiple reclaim unit handles that reference reclaim units in a reclaim group; and
a controller to receive data from a host, obtain reclaim unit handles from the data to determine locations where the data is to be stored on the flexible data placement drive, and stripe the data across reclaim units within different reclaim groups on the flexible data placement drive in parallel, wherein the storage device leverages the write amplification of the flexible data placement drive to reduce a write amplification factor on the RAID.

17. The storage device of claim 16, wherein a namespace is carved out of the flexible data placement drive and RAID volumes are carved out of the namespace.

18. The storage device of claim 16, wherein the controller performs striping and parity in any direction on the flexible data placement drive.

19. The storage device of claim 16, wherein the controller receives a multi-dimensional matrix forming any number of combinations with parallelism for striping data and parity on the flexible data placement drive.

20. The storage device of claim 16, wherein the controller performs parity calculations at a reclaim unit level.
